(19) United States
(12) Patent Application Publication
(10) Pub. No.: US 2009/0165683 A1
(43) Pub. Date: Jul. 2, 2009

(54) SECURITY DEVICE

(75) Inventor: Stein Halvor Bakke, Oslo (NO)

Correspondence Address: VOLPE AND KOENIG, P.C., UNITED PLAZA, SUITE 1600, 30 SOUTH 17TH STREET, PHILADELPHIA, PA, 19103, US

(73) Assignee: BankZone AS, Lysaker (NO)

(21) Appl. No.: 12/280,596

(22) PCT Filed: Feb. 23, 2006
(86) PCT No.: PCT/NO06/00074

§ 371 Date: Mar. 19, 2009

(51) Int. Cl. E06B 9/00

(52) U.S. Cl. 109/49.5

(57) ABSTRACT

A security device for personal security can be used with self-service units mounted on/in a wall. The security device has a fixed screen panel. The security device is provided so that it need only be fastened to the wall and so that the security device can be arranged with a gap or clearance from an underlying surface. The screen panel can have an advertising display case.

The present invention relates to a device for shielding and personal security in connection with the use of self-service units. The invention thus relates to a device for personal shielding and security in connection with the use of self-service units such as night safe deposit boxes, automated teller machines and other types of units installed in indoor or outdoor areas. More specifically, the invention relates to a device as disclosed in the preamble of claim 1.

There is a great and growing need for increased personal security and confidentiality in connection with the use of self-service units/machines such as night safes, automated machines, banknote counters, internet banks, e-banking zones and all locations where sensitive information is revealed in area/places in which other people may get hold of it.

For many years, banks the world over have been automating their cash transaction services. This is still taking place, and to an even greater extent than before. Night safes (machines for the receipt of cash) are found in all countries as an integral feature of the banks' services. Robberies often take place while clients are in the process of depositing their daily takings in the night safe. The security device according to the invention will be able to prevent robberies in such situations, and will be a highly relevant product for banks for the purpose of protecting their customers from robbery, making the service more user friendly and thus also increasing its use.

The users of automated teller machines often feel unsafe. Criminals who monitor and observe the input of a card code and later rob the person of his bank card are becoming increasingly common. The security device will give greater security against robbery at the automated teller machine and against the theft of bank cards.

Today there are security screens without movable parts which are mounted at an angle or in a curve on one or both sides of, for example, an automated teller machine. These are meant to prevent observation of the input of a code from the side.

A fixed booth or compartment installed in front of the automatic cash dispenser is also a solution found today. Often, this is in connection with a so-called “machine zone” where one or more machines are located in, for example, the entry in front of the entrance to the bank. These booths require structural changes (usually in exterior walls) and/or occupation of floor or pavement space. They are not workable for installation onto a pavement without considerable alterations in the facade and substantial costs.

Often, it is impracticable or very inconvenient to take up areas of pavement or floor (cleaning, property rights, permits etc.) in a busy zone, so that the building of a “box” on the pavement is not a relevant alternative. If the “box” is to be built “into” the wall, substantial costs will be incurred.

According to the invention there is therefore provided a security device of the type described above and as disclosed in the preamble of claim 1 below. The security device is thus characterised by the characteristic features as disclosed in independent claim 1. Preferred features of the security device according to the invention are set forth in accompanying dependent claims 2 to 9.

The object of the invention is to create a relatively safe compartment or booth for self-service dispensers or machines which are positioned with their front facing a pavement, or facing a busy public space in connection with, for example, an underground railway/public transport, shopping mall or the like.

Another object of the invention is to provide a security device for self-service units which does not involve costly modifications of the facade and which also does not take up floor or pavement space. This is achieved in that the security device is provided for attachment solely to the facade or wall and with a gap or a clearance towards an underlying surface, e.g., a pavement. The security device according to the invention also makes it practicable to have machines, such as automated teller machines in relatively unsafe or very busy areas.

In an advantageous embodiment of the invention, the security device comprises a display case for the display of advertising. Recently there have been increasingly greater restrictions on traditional advertising display cases. Since the display case is a part of the security or shielding device which is to the benefit of the general public, the security device may permit the placement of advertising display cases at places where it would otherwise be difficult to get permission to display advertising. Since the security device comprises an advertising display case, the security device can in addition be self-financing. This means that banks can without any extra costs offer their customers a better service.

The invention will now be explained in more detail with reference to the figures which show examples of advantageous embodiments of the invention:

FIG. 1 is a perspective view of an embodiment of a security device.

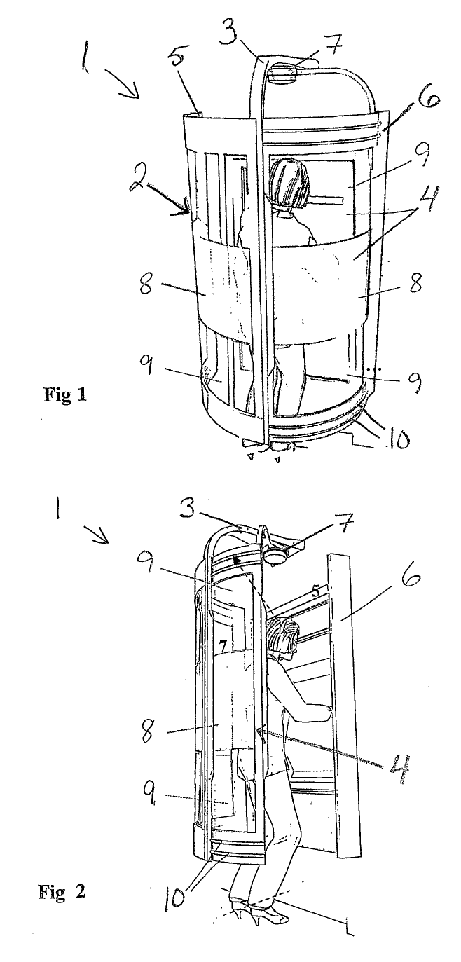

FIG. 2 shows the same embodiment as in FIG. 1 where the door is half open.

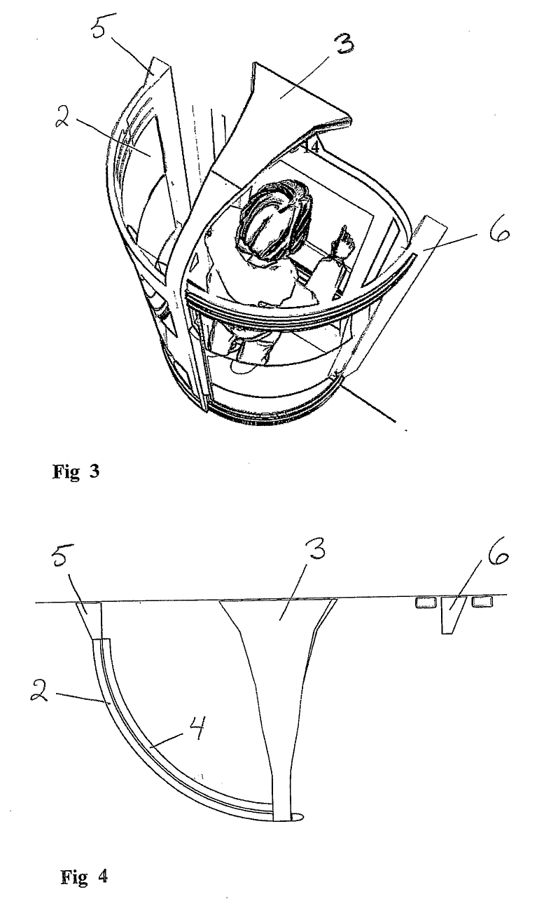

FIG. 3 shows the same embodiment as the security device in FIG. 1 seen at an angle from above.

FIG. 4 shows the same embodiment as in FIG. 1 with an open door seen from immediately above.

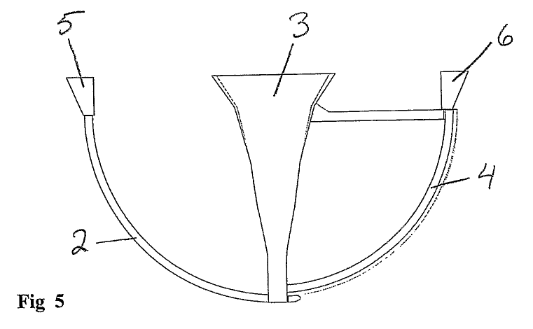

FIG. 5 shows the same embodiment as in FIG. 1 with a closed door seen from immediately above.

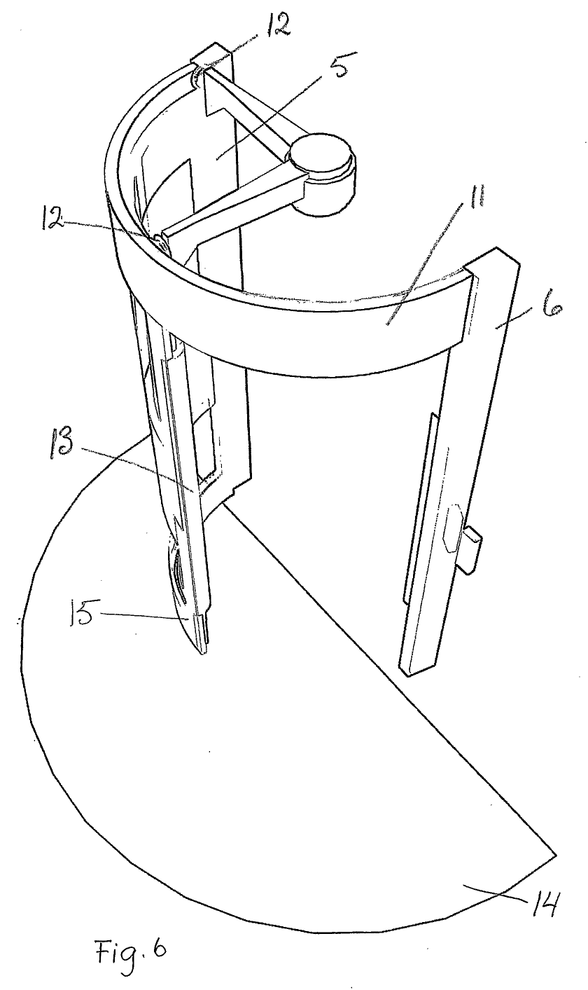

FIG. 6 shows a second embodiment of the security device.

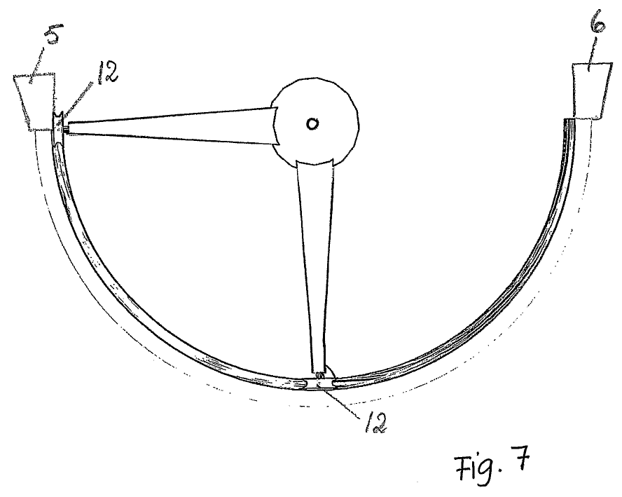

FIG. 7 shows the embodiment illustrated in FIG. 6 seen from immediately above.

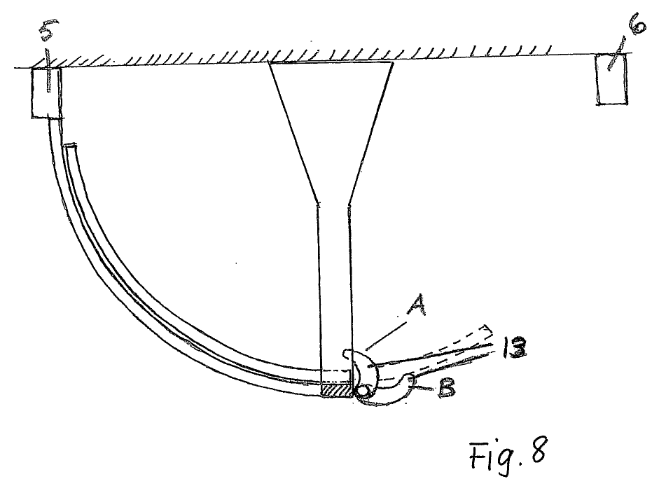

FIG. 8 shows the security device equipped with a cushioning element, seen from immediately above.

FIG. 9 shows a third embodiment of the security device.

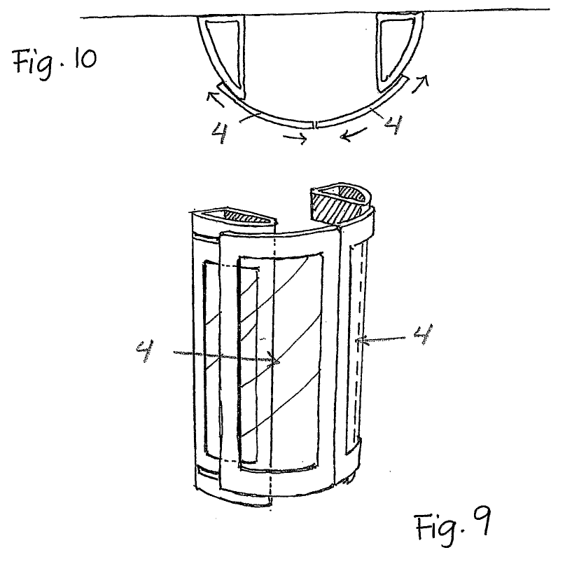

FIG. 10 shows the security device illustrated in FIG. 9 seen from immediately above.

FIG. 11 shows a fourth embodiment of the security device.

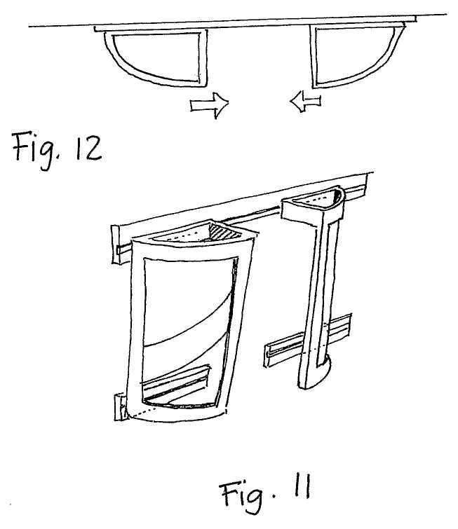

FIG. 12 shows the security device illustrated in FIG. 11 seen from immediately above.

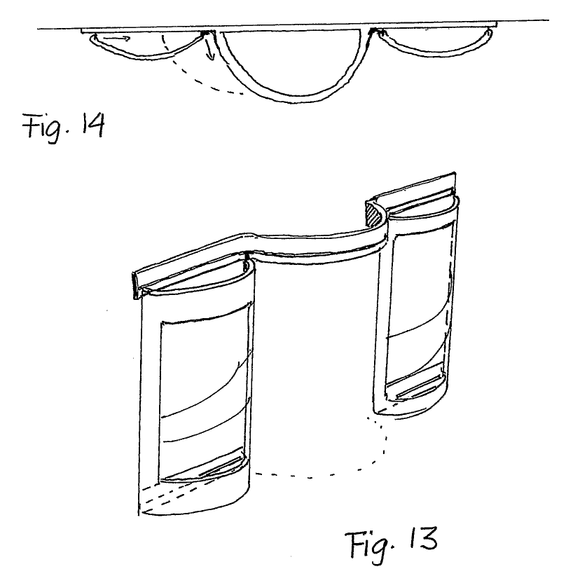

FIG. 13 shows a fifth embodiment of the security device.

FIG. 14 shows the security device illustrated in FIG. 13 seen from immediately above.

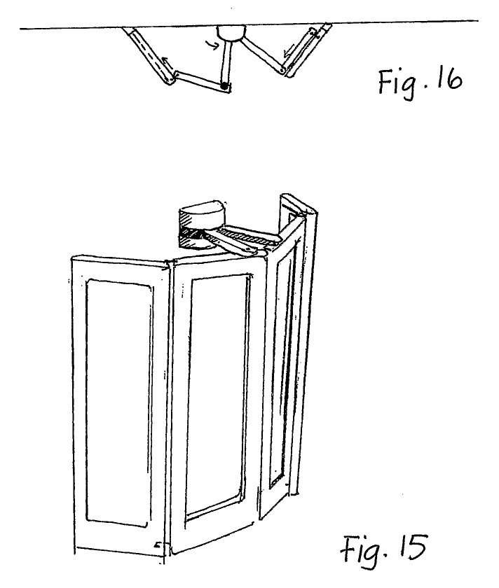

FIG. 15 shows a sixth embodiment of the security device.

FIG. 16 shows the security device illustrated in FIG. 15 seen from immediately above.

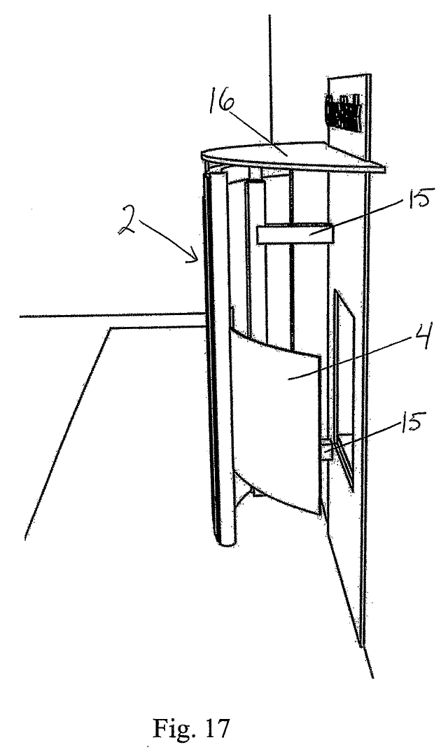

FIG. 17 shows a seventh embodiment of the security device.

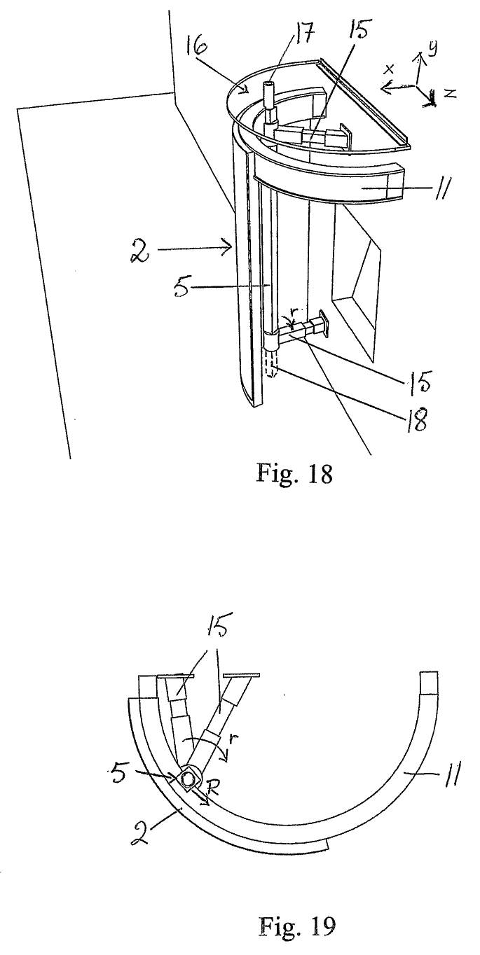

FIG. 18 shows an eighth embodiment of the security device.

FIG. 19 shows a possible attachment to a wall seen from above.

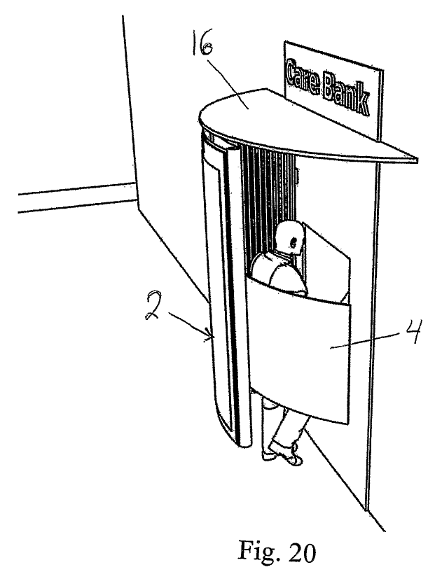

FIG. 20 shows a ninth embodiment of the security device.

FIG. 21 shows a tenth embodiment of the security device.

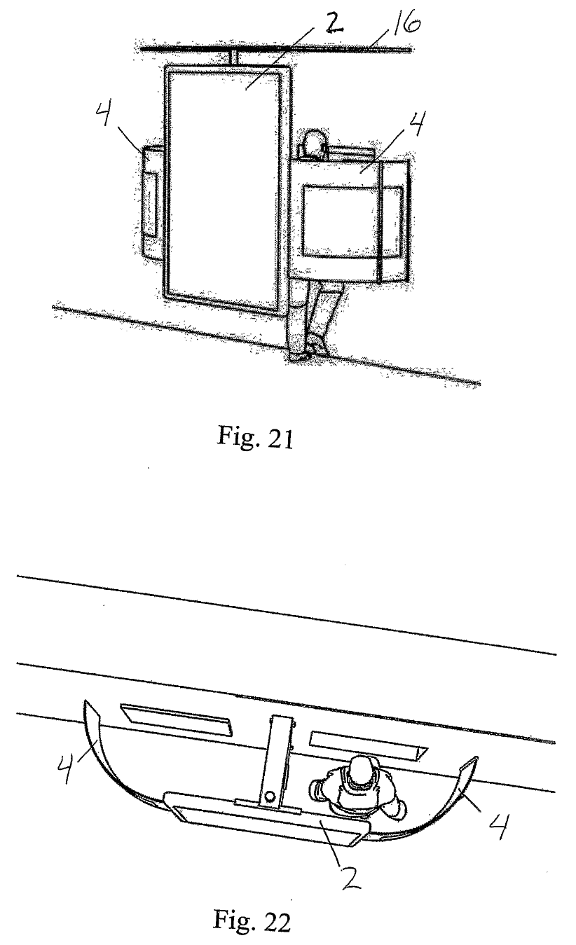

FIG. 22 shows the embodiment illustrated in FIG. 21 at an angle from above.

FIG. 1 shows a first embodiment of a security device 1 which comprises a fixed screen panel 2, top frame 3, sliding door (sliding panel) 4 and vertical side members 5 and 6. The security device 1 can be attached to the wall by means of the top frame 3 and the side member 5, and optionally the side member 6. Attachment to a wall means that there is no need to use the floor or the pavement. There is a gap or clearance between the security device 1 and the underlying surface. In most situations this is a necessity because of requirements concerning cleaning, property rights, permits, etc.

The fixed screen panel 2 may be straight or curved. In an advantageous embodiment, the security device is curved for increased strength and better conditions for pedestrians. Advantageously, the fixed screen panel 2 is a part of a circular arc as shown in FIG. 1. The sliding door/panel 4 can slide radially along the fixed screen panel 2 and axially on attachment 7 on the top frame 3.

The security device 1 is preferably mounted on the wall next to said machines, and in its simplest form it can surround the user radially on one side, or from immediately behind. In its simplest form it does not need to have a door 4.

When a radially parallel sliding door 4 is mounted to the protective screen panel 2, the user can be surrounded on all sides when the door 4 is pivoted about the link on the top beam so that the door 4 is closed. This is shown in FIG. 1. FIG. 2 shows the security device 1 when the sliding door 4 is half open. The door 4 may alternatively be of the “saloon door” type.

In an advantageous embodiment, the screen panel 2 of the security device may comprise an advertising display case. The advertising display case may be straight or curved. Optionally, the screen panel 2 may comprise a metal frame system with curved glass or polycarbonate as the protective area. The screen panel frame may advantageously be made of hollow aluminium sections.

The fixed screen panel 2 and the sliding door 4 may comprise a matt/opaque panel in the curved panels 8, and a transparent panel in the curved panels 9. The opaque panels 8 may also be covered by advertisements. Panels 8 may be advertising (plastic film or the like) or another view-blocking element that is fastened to panels 9. In an advantageous embodiment, the fixed screen panel 2 may comprise one large glass display case for the display of advertising.

When the door 4 is pivoted about the link on the top beam, it can slide on track 10 in the bottom edge of the frame. The security device 1 can thus be opened from the outside by manually sliding the door 4 open or by pressing a switch to unlock for manual or motorised opening. Optionally, a card or code may be required to open the door 4 to check who has access. When the customer stands inside the security device, he can lock the door so that he is protected as long as he remains there. Outside the zone, cameras can monitor the surrounding area. Within the zone there may be an emergency button, or a direct line to an alarm control board or other support if the customer feels he/she is in danger.

FIG. 3 shows the same embodiment of the security device 1 seen at an angle from above. FIG. 4 shows the same embodiment of the security device 1 as described above seen from immediately above when the door 4 is open. FIG. 5 shows the security device 2 seen from immediately above when the door 4 is closed.

FIG. 6 shows a second embodiment of the invention where the security device 1 comprises a fully curved supporting member 11. The curved supporting member 11 is at both ends fastened to the wall or to the side members 5 and 6. The sliding door 4 in this embodiment can run on small wheels 12 as shown in FIG. 6. The embodiment in FIG. 6 is seen from immediately above in FIG. 7 where the wheels 12 are clearly visible. The sliding door 4 may also run on another sliding guide.

When the sliding door panel 4 is open, an edge facing the pedestrian traffic from one side is formed, and this edge may cause harm if someone walks into it. This is solved by mounting a cushioning element 13 on the fixed panel 2. The cushioning element 13 may be a transparent coloured rubber or plastic part which has lights mounted on the rear side so that it is easily visible to pedestrians. It is essential to avoid the danger of collision with pedestrian traffic, and this is helped by the general shape of the device and also the fact that the sliding door 4 can be closed automatically via a motorised attachment on the top frame 3. When the sliding door 4 is closed, any collision will only be with an oblique surface instead of a part of the frame.

It is also possible to have an audible warning signal via a proximity sensor which emits a signal as a pedestrian approaches. Marking 14 on the floor or pavement via light, texture and/or elevation, which may, for example, be a couple of metres in front of the unit, is a preferred solution to this problem. Such marking is indicated in FIG. 6. Marking 14 on the floor/pavement and/or audible signal sensors will prevent blind or weak-sighted persons from colliding with the security device 1.

Attachment to a wall/facade is possible without using attachment to a floor or pavement, so that cleaning and questions of property rights become an issue of minor significance. Such attachment can be obtained by supporting top and/or bottom members on the fixed panel 9, and the top central frame 3. To strengthen and simplify the attachment of the frames and the protective panels, side members 5, 6 can be mounted in order to obtain a stronger attachment (FIG. 3), and to facilitate adjustments for structure, materials use, irregularities and decoration on the facade wall.

The cushioning element 13 is shown from immediately above in FIG. 8. When the sliding door 4 is in an open position, the cushioning element 13, which is spring-loaded, will be in position A. When the sliding door 4 is in a closed position, the cushioning element will be in position B.

In an advantageous embodiment of the security device 1, (pinhole) camera surveillance (based on infra-red and ordinary light), an alarm and sensor-controlled lighting are also installed.

FIG. 9 shows a third embodiment of the security device 1. The embodiment of the security device shown in FIG. 9 is advantageous in that it projects a slightly shorter distance from the wall than the aforementioned security devices. FIG. 10 shows the third embodiment of the security device seen from immediately above. In this embodiment, the door 4 is advantageously a double door as shown in FIGS. 9 and 10. Another variant of this embodiment may comprise a fully curved supporting member 11 as shown in FIG. 6. It is also possible to fasten an extra stay or wire to the curved supporting member 11 for extra stiffness and robustness.

The side member 5 may also be used as a duct for cabling to an external control unit (including, for example: card reader, manual button, voice control, closing button, switch for motorised opening etc.) and an internal control panel, including, for example, switches for manual opening/closing, motorised/automatic opening and closing, panic button, emergency button, button for direct call to security support/police, extra strong exterior lighting directed towards the surrounding area, an audible exterior signal/alarm etc. Complementary functions such as surveillance cameras, lighting, sensor controlled lighting, loudspeakers, microphones, sensors, alarms, can also be placed in the side members 5 and 6.

The closing of the sliding door 4 may be effected manually, or in a motorised, automatic manner. Access may take place without any restriction or by means of a card reader or code. Automatic closing may be advantageous in cases where collision with pedestrians may occur. The sliding door 4 is hinged in frame 3, and slides in tracks on the members of the fixed panel, and corresponding mechanical components on the frame of the moving panel. Linear guides both at the top and the bottom of the panel 15 increase rigidity of the structure, so that it better tolerates random blows and vandalism.

The panels 8, 9 in the frames are removable, thus allowing repair and replacement to take place. The frames may have rounded edges so that the danger of jamming is minimised. The panels may provide the possibility of advertising messages. The frames around the panels 8, 9 provide space for cabling so that advertising displays requiring electrical signals may also be used. When the door is closed automatically, the motor may advantageously have a sensor so that if anything is jammed between the frame parts or the sliding panel and the side member, the motor brakes or stops. Rounded edges on the frame parts help to reduce the risk of jamming. The mechanism for stopping/braking in the event of resistance is advantageously of the fail-safe type.

The marking/texture 14 on the pavement or floor can be adapted to the underlying surface. It can be prepared for loud-speaking function within the zone for voice recognition operation of the machine for the weak-sighted and blind.

The screen panels may also move linearly along the wall so that a booth is formed, but which permits the screen panels to be placed along the wall when the security device is not in use. This fourth embodiment is shown in FIGS. 11 and 12. FIGS. 13 and 14 shows a fifth embodiment of the security device 1 where the screen panels can move linearly and radially along the wall so that a booth is formed, but which permits the screen panels to be placed along the wall when the security device 1 is not in use. FIGS. 15 and 16 shows a sixth embodiment of the security device where the screening panels are planar, not curved.

FIGS. 17 and 18 show advantageous embodiments of the invention where the screen panel 2 is only fastened to the wall by two arms 15. There may be a gap or space between the outer edge of the screen panel 2 and the facade. There may also be a gap between the supporting member 11 and the facade. Where gaps and clearances are concerned, it is of overall importance that the security device 1 is arranged so as to prevent a third person from gaining access to information or from easily reaching cards and cash from a point outside the security device 1. The screen panel 2 may comprise an advertising display case for the display of advertising. Advantageously, the glass display case may be adapted to Euro-size (177 cm×118 cm) which is a standard size for advertising display cases.

Optionally just one arm 15 or more than two arms may be used for attachment to the facade, advantageously with the aid of bolts through (non-illustrated) holes in the end plate on each arm 15. The arm 15 can be fastened to the facade/wall at any angle, typically the angle between the arms 15 and the facade will be in the range of 90°±10°. The arms 15 are fastened to the side member 5, and can be adjusted up or down (in the y direction) according to need. The arms 15 can be adjusted and locked steplessly by means of known per se fastening and locking devices such as telescopic devices, and can thus be adjusted to any known facade. The arms 15 can thus be adjusted in the x direction so that the security device can be mounted on uneven facades. The arms 15 can also be turned about and locked to member 5 in the r direction (the r direction is shown in FIGS. 18 and 19). On turning in the r direction, the angle of the end plates to the facade will change, and the part of the telescopic arm comprising the end plate can advantageously be provided in several variants adapted to different angles of rotation.

FIG. 19 shows the security device 1 with fastening device 15 seen from above. The side member 5 may also be arranged closer to the centre of the device 1 (in the R direction, as shown in FIG. 19) for increased strength. Advantageously, the screen panel 2 is symmetric in the vertical direction (y direction) so that the panel can be mounted upside down.

In FIG. 17 the door 4 is shown as a “saloon door”. By “saloon door” here is meant a door which provides protection against observation around the self-service unit, and which does not extend as far down or as high up as the screen panel 2. The “saloon door” 4 may be a sliding door or it may be hinged to the screen panel 2 or optionally to the facade. Hinging to the screen panel 2 will however be preferable as only two points of attachment to the wall via the arms 15 can be maintained, for simple adaptation to the facade.

The security device may also have a roof 16. The roof may advantageously have a down pipe 17 for water, as shown in FIG. 18, and the roof 16 must then have a slope towards the down pipe 17. As shown in FIG. 17, the side member 5 may hold a folding, adjustable and lockable leg 18. The leg 18 may be removable. The leg 18 can function as a support when the advertising is changed/the display case is opened. Optionally, the screen panel 2 may comprise several folding or hinged legs 18. The leg/legs 18 may be useful during the assembly of the security device (1).

An additional embodiment of the security device 1 (shown in FIG. 20) may comprise a wall/ribs that conceal the arms 15.

FIGS. 21 and 22 shows an advantageous embodiment of the security device which provides screening for two self-service units.

In all the figures showing the security device 1 there is, as previously mentioned, a gap or clearance between the security device 1 and the underlying surface.

It should also be mentioned that different combinations of the different features of the different embodiments may be made.

1-9. (canceled)

10. A security device for personal shielding and security in connection with the use of self-service units mounted on or in a wall comprising a fixed screen panel, characterised in that the security device is provided for attachment to the wall only and with a gap towards an underlying surface, wherein the screen panel is fastened to a side member which is fastened to the wall by at least one arm, the arm being is adjustable and lockable in a horizontal direction, in a vertical direction and a rotational direction about the side member (5) in the horizontal plane, relative to the side member.

11. A security device according to claim 10, characterised in that the screen panel comprises an advertising display case.

12. A security device according to claim 11, characterised in that the advertising display case is adapted to Euro size.

13. A security device according to claim 10, characterised in that the arm is telescopic and comprises an end plate for attachment to the wall.

14. A security device according to claim 10, characterised in that the security device comprises a door which may be a sliding door or may be hinged to the screen panel.

15. A security device according to claim 10, characterised in that the security device comprises a folding leg.

16. A security device according to claim 10, characterised in that the screen panel is straight, curved or circular.

17. A security device according to claim 14, characterised in that the door is lockable from the inside, for protection of a user.

18. A security device according to any claim 14, characterised in that a card or code is required to open the door, to check the identify of a user.

19. A security device according to claim 14, characterised the device comprises an emergency button, or a direct line to an alarm control board or other support, for use if the user feels he/she is in danger.
